(19) United States
(12) Patent Application Publication
(10) Pub. No.: US 2026/0181346 A1
(43) Pub. Date: Jun. 25, 2026

(54) METHOD AND APPARATUS FOR RECEIVING A VOICE FROM A SPEAKER OUTSIDE A VEHICLE

(71) Applicants: HYUNDAI MOTOR COMPANY, Seoul (KR); KIA CORPORATION, Seoul (KR)

(72) Inventor: Min Sik Yang, Hwaseong-si (KR)

(73) Assignees: HYUNDAI MOTOR COMPANY, Seoul (KR); KIA CORPORATION, Seoul (KR)

(21) Appl. No.: 19/225,655

(22) Filed: Jun. 2, 2025

(30) Foreign Application Priority Data
Dec. 24, 2024 (KR) 10-2024-0195719

(51) Int. Cl. H04S 7/00; H04R 1/08

(52) U.S. Cl. CPC H04S 7/303; H04R 1/08; H04R 2499/13

(57) ABSTRACT

Disclosed is a method and apparatus for receiving voice from a speaker outside a vehicle. A method for receiving voice according to an embodiment of the present disclosure includes determining position information of a speaker outside a vehicle based on an image captured by a camera when an external call mode, which receives voice from the speaker outside the vehicle, is activated, opening a window of the vehicle, taking into account noise based on the degree of opening and closing, and controlling beamforming of voice received by an array of microphones based on the determined position information of the speaker.

### CROSS-REFERENCE TO RELATED APPLICATION

The present application claims priority to Korean Patent Application No. 10-2024-0195719 filed on Dec. 24, 2024, the entire contents of which are incorporated herein for all purposes by this reference.

### TECHNICAL FIELD

The present disclosure relates to a vehicle, and more particularly, to a method and apparatus for controlling the vehicle and receiving voice based on the position of a speaker outside the vehicle.

### BACKGROUND

A vehicle is a device designed to transport users in a desired direction. For the convenience of vehicle users, various sensors and electronic devices are being installed in the vehicle. In particular, research on Advanced Driver Assistance Systems (ADAS) is being actively conducted for the convenience of users' driving, and furthermore, development of robo-taxis utilizing autonomous driving technology is being actively conducted.

To use a robo-taxi, communication between a speaker (i.e., a person) outside the vehicle and a control center located at a remote distance from the robo-taxi is required. There are no difficulties in transmitting the voice of the control center to the speaker (e.g., rider) outside the vehicle through the vehicle's external speaker. However, receiving the voice of the speaker outside the vehicle through the vehicle's internal microphone is challenging due to factors such as the distance between the speaker outside the vehicle and the vehicle, and the structure of windows.

### SUMMARY

In view of the foregoing, there is a demand for a technology that may efficiently receive the voice of a speaker outside the vehicle.

Various aspects of the present disclosure provide a technology that may efficiently receive the voice of a speaker outside the vehicle, based on (e.g., taking into account) factors such as the speaker's height and position.

Various aspects of the present disclosure identify the position of the speaker outside the vehicle and set the optimal microphone beamforming angle based on the real-time changes in the position of the speaker outside the vehicle, thereby optimizing the performance of receiving the voice of the speaker outside the vehicle using the vehicle's internal microphone.

The technical objects or aspects disclosed in the present disclosure are not limited to the aforementioned technical objects or aspects, and other unmentioned technical objects or aspects should be clearly appreciated by those having ordinary skill in the art from the description below.

A method for receiving voice according to an embodiment of the present disclosure includes: determining position information of a speaker outside a vehicle based on an image captured by a camera when an external call mode for receiving voice from the speaker outside the vehicle is activated (or based an external call mode for receiving voice from the speaker outside the vehicle being activated); opening a window of the vehicle, taking into account (or based on) noise based on the degree of opening and closing; and controlling beamforming of voice received by an array of microphones based on the determined position information of the speaker.

Controlling the beamforming may include delaying the phase of the received voice (e.g., voice received by the array of microphones) and removing or reducing noise included in the voice (e.g., voice received by the array of microphones).

The position information of the speaker may include a relative position indicating the front or rear of the vehicle and a height of the speaker.

The phase of the voice received by the array of microphones may be delayed by a predetermined angle based on the position information of the speaker.

The phase of the voice received by the array of microphones may be delayed based on the result of comparing the height of the speaker with a height at which the window is opened.

Removing or reducing the noise may include delaying the phase of the voice received by the array of microphones based on the height at which the window is opened and the position information of the speaker, when the window is opened higher than the height of the speaker (or based on the window being opened higher than the height of the speaker).

Opening the window of the vehicle may include: controlling the window to move up and down; and setting a height of the window to a height capable of minimizing the noise by comparing the noise based on the height of the window (or to a height at which the noise has a lowest value among values determined based on comparing the noise based on the height of the window).

The method for receiving voice may further include resetting the height of the window based on the result of comparing the height of the speaker with the height at which the window is opened.

The external call mode may be activated when detection information about the speaker is received from the camera (or based on detection information about the speaker received from the camera).

An apparatus for receiving voice according to an embodiment of the present disclosure includes: a camera configured to capture an image of a speaker outside a vehicle; and a head unit. The head unit is configured to determine position information of the speaker outside the vehicle based on the image captured by the camera when an external call mode for receiving voice from the speaker outside the vehicle is activated (or based on an external call mode for receiving voice from the speaker outside the vehicle being activated), to open a window of the vehicle, taking into account (or based on) noise based on the degree of opening and closing, and to control beamforming of voice received by an array of microphones based on the determined position information of the speaker.

The head unit may control the beamforming by delaying the phase of the received voice (e.g., the voice received by the array of microphones) to remove or reduce noise included in the voice (e.g., the voice received by the array of microphones).

The phase of the voice received by the array of microphones may be delayed by a predetermined angle based on the position information of the speaker.

The phase of the voice received by the array of microphones may be delayed based on the result of comparing a height of the speaker with a height at which the window is opened.

The head unit may delay the phase of the voice received by the array of microphones based on the height at which the window is opened and the position information of the speaker, when the window is opened higher than the height of the speaker (or based on the window being opened higher than the height of the speaker).

The head unit may control the window to move up and down and set a height of the window to a height capable of minimizing the noise by comparing the noise based on the height of the window (or to a height at which the noise has a lowest value among values determined based on comparing the noise based on the height of the window).

The head unit may reset the height of the window based on the result of comparing the height of the speaker with the height at which the window is opened.

The external call mode may be activated when detection information about the speaker is received from the camera or based on detection information about the speaker received from the camera.

An apparatus for receiving voice according to an embodiment of the present disclosure includes: a camera configured to capture an image of a speaker outside a vehicle; and a head unit. The head unit is configured to: determine position information of the speaker outside the vehicle based on the image captured by the camera based on an external call mode for receiving voice from the speaker outside the vehicle being activated; set a height of a window of the vehicle based on noise based on a degree of opening and closing of the window; and control beamforming of voice received by one or more microphones based on the position information of the speaker.

The head unit may control the beamforming by delaying a phase of the voice received by the one or more microphones to reduce noise included in the voice received by the one or more microphones.

Based on embodiments of the present disclosure described so far, the voice of the speaker outside the vehicle may be efficiently received by taking into account (or based on) factors such as the speaker's height and position.

In addition, the position of the speaker outside the vehicle may be identified, and the optimal microphone beamforming angle may be set based on the real-time changes in the position of the speaker outside the vehicle, thereby optimizing the performance of receiving the voice of the speaker outside the vehicle using the vehicle's internal microphone.

The effects of the present disclosure are not limited to those mentioned above. Other unmentioned effects should be clearly understood by those having ordinary skill in the art from the description below.

### BRIEF DESCRIPTION OF THE DRAWINGS

FIG. 1 is a block diagram schematically showing an example of an apparatus for receiving voice according to an embodiment of the present disclosure.

FIG. 2 shows an example in which a speaker's voice is received at a default beamforming direction angle that is not controlled based on the speaker's position.

FIG. 3 shows an example in which an optimal beamforming angle is controlled based on the speaker's position, allowing the speaker's voice to be received.

FIG. 4 shows an example in which the speaker's position relative to a vehicle's position is displayed on a coordinate plane.

FIG. 5 is a flowchart showing an example of a method for receiving voice according to an embodiment of the present disclosure.

FIG. 6 is a flowchart showing an example of a method for receiving voice according to another embodiment of the present disclosure.

### DETAILED DESCRIPTION

Hereinafter, embodiments disclosed in the present specification are described in detail with reference to the drawings. The same reference numerals are given to the same or similar components regardless of reference numerals, and a repetitive description thereof has been omitted. As used in the following description, suffixes “unit,” “module,” and “part” for a component are used or interchangeably used solely for ease of preparation of the specification, and do not have different meanings and each of them does not function by itself. In describing embodiments disclosed in the present specification, when a detailed description of a known related art is determined to obscure the gist of embodiments disclosed in the present specification, the detailed description thereof has been omitted herein. In addition, the accompanying drawings are merely for easy understanding of embodiments disclosed in the present specification, the technical spirit disclosed in the present specification is not limited by the accompanying drawings, and it should be understood to include all modifications, equivalents, and substitutes included in the spirit and scope of the present disclosure.

Terms including ordinal numbers such as first, second, and the like used herein may be used to describe various components, but the various components are not limited by these terms. The terms are used only for the purpose of distinguishing one component from another component.

When a component is referred to as being “connected” or “coupled” to another component, the component may be directly connected or coupled to another component, but it should be understood that still another component may be present between the component and another component. Conversely, when a component is referred to as being “directly connected” or “directly coupled” to another, it should be understood that still another component may not be present between the component and another component.

Unless the context clearly dictates otherwise, the singular form includes the plural form.

In the present specification, the terms “comprising,” “having,” “including,” or the like are used to specify that a feature, a number, a step, an operation, a component, an element, or a combination thereof described herein exists, and they do not preclude the presence or addition of one or more other features, numbers, steps, operations, components, elements, or combinations thereof.

When a component, unit, controller, device, element, apparatus, or the like of the present disclosure is described as having a purpose or performing an operation, function, or the like, the component, unit, controller, device, element, apparatus, or the like should be considered herein as being “configured to” meet that purpose or to perform that operation or function. Each component, unit, controller, device, element, apparatus, and the like may separately embody or be included with a processor and a memory, such as a non-transitory computer readable media, as part of the apparatus.

The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

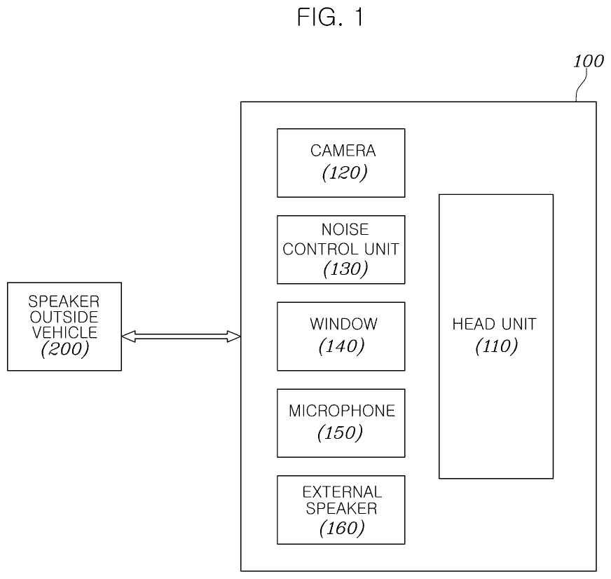

FIG. 1 is a block diagram schematically showing an example of an apparatus for receiving voice according to an embodiment of the present disclosure.

Referring to FIG. 1, an apparatus for receiving voice 100 according to the present embodiment includes a head unit 110, a camera 120, a noise control unit 130, a window 140, a microphone or microphone system 150, and an external speaker 160.

When an external call mode is activated, the head unit 110 controls the noise control unit 130 to minimize or reduce noise (i.e., a level of noise from inside or outside the vehicle, or from the vehicle itself), measures the noise, and controls a vehicle's window 140 to set a height of the window 140 that may minimize or reduce noise while clearly receiving the voice of a speaker (i.e., person, such as a potential rider or passenger) 200 outside the vehicle from the microphone system 150.

The external call mode may be activated when a speaker outside the vehicle is detected based on an image received from the camera 120.

In addition, the head unit 110 determines the position of the speaker based on the image captured by the camera 120, and controls the beamforming of the microphone system 150 in real time based on the position of the speaker.

Beamforming here refers to a technology in which multiple microphones capture sound sources with specific phase values and suppress sound sources with different phase values. This technology is used to remove or reduce unwanted noise and receive only the target sound source.

Phase delay is applied to the signals received by each microphone in order to obtain the target sound source, and the signals from all the microphones with the applied phase delay may be synthesized. As a result, sound from a specific direction may be captured with focus, and noise from other directions may be suppressed.

For example, the voice signal received by the microphone system 150 at a specific time t and at the position r of the target sound source may be defined using Equation 1 below.

$$P ( t , r ) = \frac{1}{N} \times {\sum }_{i = 1}^{n} p ( t - {Δ}_{i} ( r ) ) \qquad [ Equation 1 ]$$

In Equation 1, P(t, r) represents the voice signal received by a microphone of the microphone system 150 at a specific time t and at the position r of the target sound source, N represents the total number of microphones that make up the microphone system 150, and p(t-Δᵢ(r)) represents the microphone's received signal with the applied phase delay Δᵢ(r).

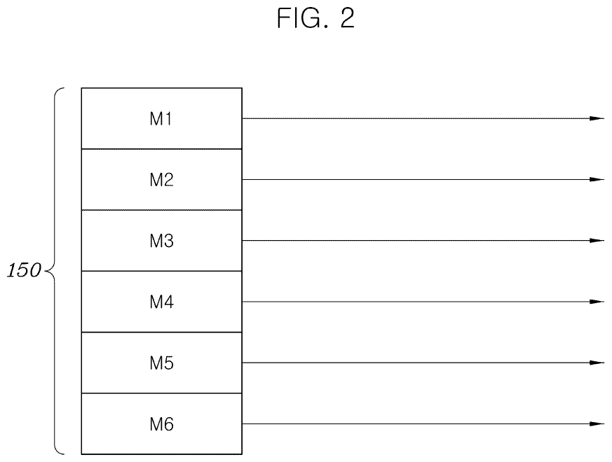

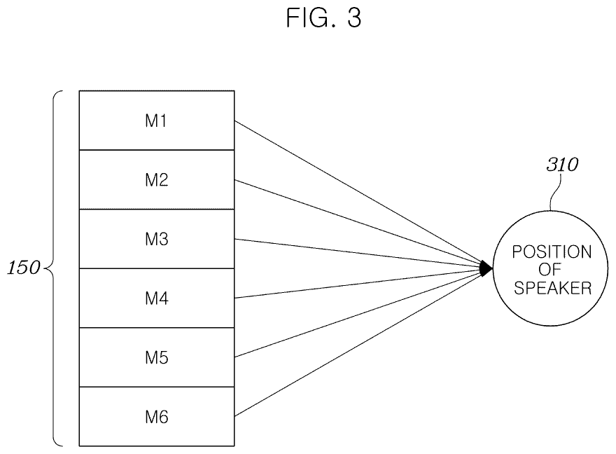

The microphone system 150, as shown in FIG. 2, includes multiple microphones M1, M2, M3, M4, M5, M6, and the voice signals received by each of these microphones are synthesized to receive the speaker's voice. Although FIGS. 2 and 3 illustrate 6 microphones M1, M2, M3, M4, M5, M6, the number of the microphones included in the microphone system 150 may vary. For example, the microphone system 150 may include 4 microphones or 9 microphones. However, without separate control of the beamforming angle, phase delay based on the position of the speaker is not applied, and the speaker's voice may be received at the same volume from all positions.

When the sum of the speaker's voice received at a default beamforming direction angle, without applying the beamforming angle based on the speaker's position, is defined as S(t), S(t) may be calculated using Equation 2 below.

$$S ( t ) = {\sum }_{i = 1}^{n} p ( t ) \qquad [ Equation 2 ]$$

In Equation 2, s(t) represents the sum of the speaker's voice received by a microphone array at a specific time t at the default beamforming direction angle, and p(t) represents the received signal of each microphone at the specific time t. In addition, i represents each microphone that makes up the microphone array.

In addition, as shown in FIG. 3, to minimize or reduce noise and receive the speaker's voice from a position 310 of the speaker, the microphone system 150 may receive the speaker's voice by delaying the phase angle based on the beamforming direction angles of the microphones M1, M2, M3, M4, M5, M6 that make up the microphone system 150.

To minimize or reduce noise and receive the speaker's voice, when the sum of the speaker's voice received at the optimized beamforming angles of the microphones M1, M2, M3, M4, M5, M6 that make up the microphone system 150 is defined as S′(t), S′(t) may be calculated using Equation 3 below.

$${S}^{′} ( t ) = {\sum }_{i = 1}^{n} p ( t - Δ xy ) \qquad [ Equation 3 ]$$

In Equation 3, S′(t) represents the sum of the speaker's voice received at a specific time t by delaying the phase angle based on the corrected beamforming direction angle, and p (t-Δxy) represents the received signal of each microphone with the phase angle delayed by Δxy.

The phase delay value Δxy may be a value that is optimized and determined based on a relative distance between the speaker and the vehicle.

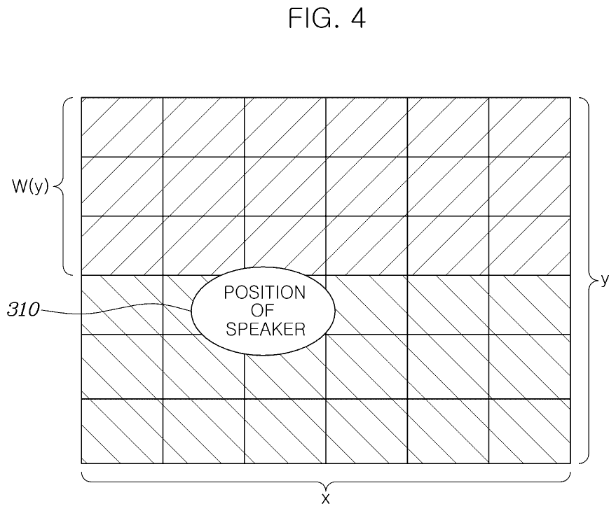

The position of the speaker may be represented by x and y coordinates, as shown in FIG. 4, for example.

If the speaker is in close proximity to the vehicle, the x-coordinate may represent a relative position indicating the front of or rear of the vehicle, i.e., the relative position toward the front or rear of the vehicle based on a plane extending to both sides of the center of the vehicle, and the y-coordinate may represent the speaker's height from the ground.

S′(t) may be represented as S(t)*A(x, t), which is the convolution of S(t) with the phase delay matrix A(x, y).

The phase delay matrix A(x, y) may be a matrix in which phase angles are mapped to delay the phase of the sound based on the speaker's position, allowing the received sound to be delayed by different phase angles according to the speaker's position information.

The phase delay matrix A(x, y) may be predetermined to suit the conditions of the vehicle and stored in a storage device such as in-vehicle memory.

Furthermore, at the beamforming direction angle (for example, the beamforming direction angle of FIG. 3), the speaker's voice S″(t) received by the microphone system 150 may be represented, for example, as shown in Equation 4 below, by delaying the phase angle based on the window height W(y) and the y-axis coordinate value corresponding to the speaker's height, as shown in FIG. 4.

$${S}^{″} ( t ) = S ( t ) ⋆ A ( x , y ) ‖ W ( y ) \qquad [ Equation 4 ]$$

In Equation 4, S″(t) represents the sum of the speaker's voice received with an optimized beamforming angle when the window 140 is opened to a height of W(y), and W(y) represents the height of the window opened from the ground (i.e., the height of the top of the window from the ground, when the window is opened).

Referring back to FIG. 4, if the vehicle's window 140 is opened lower than the y-axis coordinate value representing the speaker's height (in other words, if the top of the window 140, when opened, is lower than the speaker's height), the head unit 110 may delay the phase angle of the speaker's voice with a phase angle optimized based on the speaker's position.

However, if the vehicle's window 140 is only open to a height above the y-axis coordinate value representing the speaker's height (in other words, the top of the window 140, when opened, is higher than the speaker's height), the speaker's voice may be partially blocked by the vehicle's window 140 and received accordingly.

If the vehicle's window 140 is opened higher than the speaker's height, i.e., higher than the speaker's stature, the head unit 110 may determine the speaker's height, i.e., the y-axis coordinate, to be W(y), the height at which the window is opened, and delay the phase angle of the microphone system 150 based on this information.

The head unit 110 may delay the phase angle of the microphone system 150 based on the speaker's position and the height at which the window 140 is opened, as described above. However, the head unit 110 may open the window 140 further based on the speaker's position to receive the speaker's voice.

The camera 120 includes at least one camera that captures the surroundings of the vehicle and transmits the captured data to the head unit 110.

The speaker's position information may be represented as a two-dimensional value with x and y coordinates.

For the speaker's position information, assuming the origin is at a horizontal position on both sides of the vehicle's center, the x-coordinate may represent a relative position, where distances forward from the horizontal position on both sides of the vehicle's center are positive values, and distances backward are negative values. The y-coordinate may represent the speaker's height from the ground.

The noise control unit 130, upon receiving a request from the head unit 110 to activate an operation, in response thereto, measures the vehicle's noise while cancelling noise in real time and transmits the measured noise to the head unit 110.

The noise control unit 130 may be the vehicle's ANC-R (Active Noise Control-Road) system.

Although not shown in the drawing, the noise control unit 130 may include a controller, an acceleration sensor, and a microphone to measure the vehicle's noise while cancelling noise in real time.

The window 140 may include at least one window that is mounted on each door of the vehicle to be automatically opened and closed. For example, the window 140 may include four windows, one mounted on each door.

The window 140 may be controlled by the head unit 110 to adjust the degree of opening and closing, thereby setting the height of the window 140 that may minimize noise.

The microphone system 150 includes at least one microphone installed inside the vehicle, which receives the voice of a speaker outside the vehicle. Under the control of the head unit 110, the beamforming angle of at least one microphone included in the microphone system 150 is controlled in real time.

The microphone system 150 may include an array of multiple microphones, with the beamforming angle set based on the speaker's position captured by the camera 120, allowing the reception of the speaker's voice.

The external speaker 160 provides the necessary information to the speaker 200 outside the vehicle.

The external speaker 160 may, for example, provide communication with the vehicle's control center or provide a notification to the speaker 200.

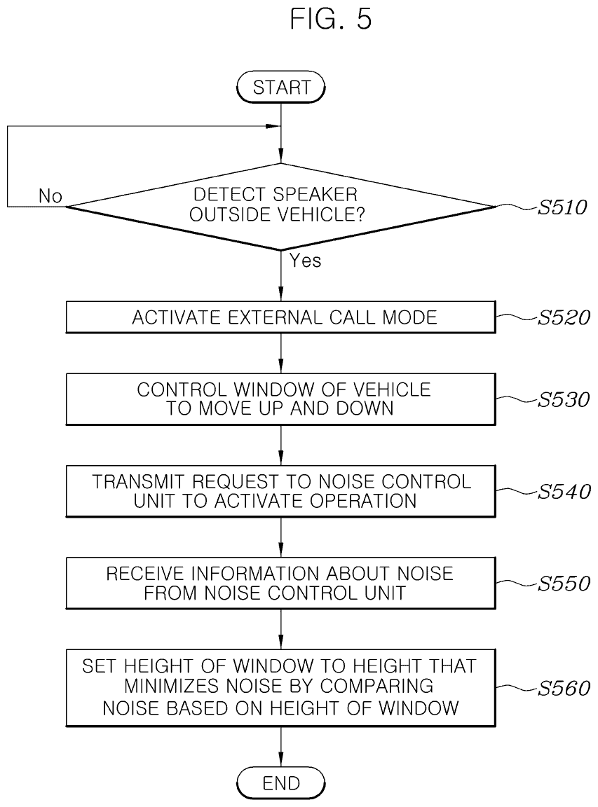

FIG. 5 is a flowchart showing an example of a method for receiving voice according to an embodiment of the present disclosure.

The method for receiving voice according to the present embodiment may be performed by the head unit 110 of the embodiment of FIG. 1.

Referring to FIG. 5, the head unit 110 determines whether a speaker outside the vehicle has been detected from the image received from the camera 120 (S110). If a speaker outside the vehicle is detected (“Yes” at S510), the external call mode is activated (S520).

When the external call mode is activated, the head unit 110 controls the vehicle's window 140 to move up and down, adjusting the height thereof to measure noise based on the height of the window 140 (S530) and transmits a request to the noise control unit 130 to activate an operation (S540).

The noise control unit 130, upon receiving a request from the head unit 110 to activate an operation, in response thereto, measures the vehicle's noise while cancelling noise in real time and transmits the measured noise to the head unit 110.

The head unit 110 receives information about noise from the noise control unit 130 (S550) and sets the height of the window 140 to a height that may minimize noise by comparing the noise based on the height of the window 140 or to a height at which the noise has a lowest value among values determined based on comparing the noise based on different heights of the window (S560).

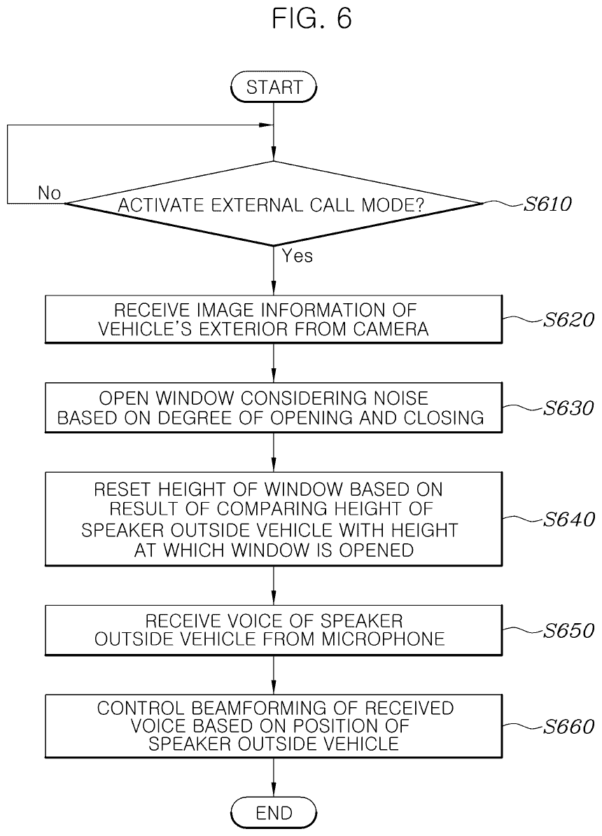

FIG. 6 is a flowchart showing an example of a method for receiving voice according to another embodiment of the present disclosure.

The method for controlling a vehicle according to the present embodiment may be performed by the head unit 110 of FIG. 1.

Referring to FIG. 6, the head unit 110 determines whether the external call mode is activated (S610). If the external call mode is activated (“Yes” at S610), the head unit 110 receives image information of the vehicle's exterior from the camera 120 (S620) and opens the window 140, taking into account noise based on the degree of opening and closing (S630).

For example, the head unit 110 may set the height of the window 140 to a height that may minimize noise.

The head unit 110 may set the height of the window 140 to a height that may minimize noise based on the position information of a speaker outside the vehicle.

The head unit 110 transmits a request to the noise control unit 130 to activate an operation. Upon receiving noise information, in response thereto, the head unit 110 may control the opening and closing of the window 140 to a height of the window 140 that may minimize noise by comparing the noise based on the height of the window 140 (i.e., based on the different heights of the window 140 and corresponding noise level based thereon).

The noise control unit 130 may measure noise while cancelling noise and transmit the measured noise to the head unit 110.

In addition, the head unit 110 may reset the height of the window 140 based on the result of comparing the height of the speaker outside the vehicle with the height at which the window 140 is opened (S640).

The step S640 is not mandatory and may be omitted depending on the situation of the vehicle.

In addition, the head unit 110 receives the voice of the speaker outside the vehicle from the microphone system 150 (S650) and controls the beamforming of the voice received by the microphone system 150 based on the position of the speaker outside the vehicle (S660).

The head unit 110 may delay the phase of the voice of the speaker outside the vehicle, received from the microphone system 150, to remove or reduce noise included in the voice.

The head unit 110 may delay the phase angle of the voice received by the microphone system 150 based on the window height W(y) and the speaker's height, i.e., the speaker's stature.

The speaker's voice, with noise removed or reduced, may be transmitted to an external device or external server and be used for communication between the speaker outside the vehicle and a service manager located at a remote distance from the vehicle.

Based on embodiments of the present disclosure described so far, the voice of the speaker outside the vehicle may be efficiently received by taking into account factors such as the speaker's height and position.

In addition, the position of the speaker outside the vehicle may be identified, and the optimal microphone beamforming angle may be set based on the real-time changes in the position of the speaker outside the vehicle, thereby optimizing the performance of receiving the voice of the speaker outside the vehicle using the vehicle's internal microphone.

The present disclosure described above may be implemented as a computer-readable code on a program-recorded medium. A computer-readable medium includes any type of recording device on which data is stored that can be read by a computer system. Examples of computer-readable media include hard disk drives (HDDs), solid state disks (SSDs), silicon disk drives (SDDs), read-only memories (ROMs), random access memories (RAMs), compact disc ROMS (CD-ROMs), magnetic tapes, floppy disks, and optical data storage devices. Therefore, the above detailed description should be considered examples rather than restrictive in all aspects. The scope of the present disclosure should be determined by a reasonable interpretation of the appended claims, and all modifications within the equivalent scope of the present disclosure are included within the scope of the present disclosure.

What is claimed is:

1. A method for receiving voice, the method comprising:
determining position information of a speaker outside a vehicle based on an image captured by a camera based on an external call mode for receiving voice from the speaker outside the vehicle being activated;
opening a window of the vehicle based on an amount of noise; and
controlling beamforming of voice received by an array of microphones based on the position information of the speaker.

2. The method of claim 1, wherein controlling the beamforming includes:
delaying a phase of the voice received by the array of microphones; and
reducing noise included in the voice received by the array of microphones.

3. The method of claim 2, wherein the phase of the voice received by the array of microphones is delayed based on a result of comparing a height of the speaker with a height at which the window is opened.

4. The method of claim 3, wherein reducing the noise includes delaying the phase of the voice received by the array of microphones based on the height at which the window is opened and the position information of the speaker, based on the window being opened to a height higher than the height of the speaker.

5. The method of claim 1, wherein the position information of the speaker includes a relative position indicating a front or a rear of the vehicle and a height of the speaker.

6. The method of claim 1, wherein a phase of the voice received by the array of microphones is delayed by a predetermined angle based on the position information of the speaker.

7. The method of claim 1, wherein opening the window of the vehicle includes:
controlling the window to move up and down; and
setting a height of the window to a height at which the amount of noise has a lowest value among values determined based on comparing noise levels corresponding to various heights of the window.

8. The method of claim 1, further comprising
resetting a height of the window based on a result of comparing a height of the speaker with a height at which the window is opened.

9. The method of claim 1, wherein the external call mode is activated based on detection information about the speaker received from the camera.

10. An apparatus for receiving voice, the apparatus comprising:
a camera configured to capture an image of a speaker outside a vehicle; and
a head unit configured to determine position information of the speaker outside the vehicle based on the image captured by the camera based on an external call mode for receiving voice from the speaker outside the vehicle being activated, to open a window of the vehicle based on an amount of noise, and to control beamforming of voice received by an array of microphones based on the position information of the speaker.

11. The apparatus of claim 10, wherein the head unit is configured to control the beamforming by delaying a phase of the voice received by the array of microphones to reduce noise included in the voice received by the array of microphones.

12. The apparatus of claim 10, wherein the position information of the speaker includes a relative position indicating a front or a rear of the vehicle and a height of the speaker.

13. The apparatus of claim 10, wherein a phase of the voice received by the array of microphones is delayed by a predetermined angle based on the position information of the speaker.

14. The apparatus of claim 10, wherein a phase of the voice received by the array of microphones is delayed based on a result of comparing a height of the speaker with a height at which the window is opened.

15. The apparatus of claim 14, wherein the head unit is configured to delay the phase of the voice received by the array of microphones based on the height at which the window is opened and the position information of the speaker, based on the height at which the window is opened being higher than the height of the speaker.

16. The apparatus of claim 10, wherein the head unit is configured to:
control the window to move up and down; and
set a height of the window to a height at which the amount of noise has a lowest value among values determined based on comparing noise levels corresponding to various heights of the window.

17. The apparatus of claim 10, wherein the head unit is configured to reset a height of the window based on a result of comparing a height of the speaker with a height at which the window is opened.

18. The apparatus of claim 10, wherein the external call mode is activated based on detection information about the speaker received from the camera.

19. An apparatus for receiving voice, the apparatus comprising:
a camera configured to capture an image of a speaker outside a vehicle; and
a head unit configured to
determine position information of the speaker outside the vehicle based on the image captured by the camera based on an external call mode for receiving voice from the speaker outside the vehicle being activated,
set a height of a window of the vehicle based on noise corresponding to a degree of opening and closing of the window, and
control beamforming of voice received by one or more microphones based on the position information of the speaker.

20. The apparatus of claim 19,
wherein the head unit is configured to control the beamforming by delaying a phase of the voice received by the one or more microphones to reduce noise included in the voice received by the one or more microphones.
